(19) United States
(12) Patent Application Publication
(10) Pub. No.: US 2014/0261980 A1
(43) Pub. Date: Sep. 18, 2014

(54) APPARATUS AND METHOD FOR PRODUCING A MULTI-AXIS LAMINATE

(71) Applicant: MILLPORT ASSOCIATES S.A., City of Panama, PA (US)

(72) Inventor: Ulrich Schwartau, Port d Andratx (ES)

(73) Assignee: MILLPORT ASSOCIATES S.A., City of Panama (PA)

(21) Appl. No.: 13/826,169

(22) Filed: Mar. 14, 2013

(51) Int. Cl. B32B 38/18; B32B 37/20; B32B 38/08

(52) U.S. Cl. CPC B32B 38/1816; B32B 38/08; B32B 37/20
USPC 156/182; 156/549; 156/547; 156/539; 156/324; 156/60

(57) ABSTRACT

A system and method of forming a multi-axis laminate including a production surface, a reinforcement material supply, and a resin supply, wherein the reinforcement material supply supplies a first layer of reinforcement material having a first fiber orientation to the production surface and a second layer of reinforcement material having a second fiber orientation on top of the first layer of reinforcement material, and wherein resin from the resin supply impregnates the first and the second layers of reinforcement material to form a laminate having a multi-axis fiber orientation. The reinforcement material supply may be a fiberglass material having a tri-axis fiber orientation that is layered to form a quatro-axis laminate.

### TECHNICAL FIELD OF THE INVENTION

The present invention relates generally to an apparatus and method for manufacturing laminate, and more particularly, to a system and method for producing multi-axis laminate.

### DESCRIPTION OF THE RELATED ART

There is an increasing global demand for lower cost buildings such as houses, warehouses and office space. The demand for lower cost buildings is particularly strong in developing countries where economic resources may be limited and natural resources and raw materials may be scarce. For example, in areas of the Middle East or Africa, conventional building materials such as cement, brick, wood or steel may not be readily available or, if available, may be very expensive. In other areas of the world, poverty may make it too costly for people to build houses or other buildings with conventional materials.

The demand for lower cost housing also is high in areas afflicted by war or natural disasters, such as hurricanes, tornados, floods, and the like. These devastating events often lead to widespread destruction of large numbers of buildings and houses, especially when they occur in densely populated regions. The rebuilding of areas affected by these events can cause substantial strain on the supply chain for raw materials, making them difficult or even impossible to obtain. Furthermore, natural disasters often recur and affect the same areas. If a destroyed building is rebuilt using the same conventional materials, it stands to reason that the building may be destroyed or damaged again during a similar event.

It is generally desirable to increase speed of construction and to minimize construction costs. Prefabricated or preassembled components can streamline production and reduce both the time and the cost of building construction. Prefabricated buildings, however, are made from conventional materials that may be scarce or expensive to obtain. Thus, there exists a need for alternative materials and techniques for constructing buildings that use advanced material technologies to increase the speed of construction and to reduce or to lower ownership costs.

### SUMMARY

The present invention provides an alternative to conventional construction materials and techniques. Buildings, such as houses, commercial buildings, warehouses, or other structures can be constructed by composite sandwich panels (also referred to as “sandwich panels” or “composite panels” or “panels”), which have an insulative core and one or more outer layers, for example, layers of laminate. The buildings can be constructed by gluing several sandwich panels together, and usually traditional fasteners, such as screws, rivets, nails, etc., are not needed for such connections. Generally, composite sandwich panels offer a greater strength-to-weight ratio than traditional materials that are used by the building industry. The composite sandwich panels are generally as strong as, or stronger than, traditional materials including wood-based and steel-based structural insulation panels, while being lighter in weight. Because they weigh less than traditional building materials, the handling and transport of composite sandwich panels is generally less expensive. The composite sandwich panels also can be used to produce light-weight structures, such as floating houses, mobile homes, or travel trailers, etc.

Sandwich panels generally are more elastic or flexible than conventional materials such as wood, concrete, steel or brick and, therefore, monolithic (e.g., unitary or single unit structure) buildings made from sandwich panels generally are more durable than buildings made from conventional materials. For example, sandwich panels also may be non-flammable, waterproof, very strong and durable, and in some cases able to resist hurricane-force winds (up to 300 Kph (kilometers per hour) or more). The sandwich panels also may be resistant to the detrimental effects of algae, fungicides, water, and osmosis. As a result, buildings constructed from sandwich panels may be better able to withstand earthquakes, floods, tornados, hurricanes, fires and other natural disasters than buildings constructed from conventional materials.

Sandwich panel structures may be less expensive to build than structures built from conventional materials because of reduced material costs and alternative construction techniques. The ownership and maintenance costs for sandwich panel structures also may be less over the long term because sandwich panel structures may last longer and degrade at a slower rate than buildings made from conventional materials. Structures built from sandwich panels therefore may require less maintenance and upkeep than structures built from conventional building materials, which may reduce the overall ownership costs for end users.

The insulative core of the sandwich panels also may reduce the amount of energy needed to heat and/or cool the building, which may reduce the overall costs to operate the building. The insulative core also may reduce or eliminate the need for additional insulation in the building, as may be necessary to insulate structures built from conventional building materials. Sandwich panel structures therefore may be less expensive to build and operate than buildings constructed from conventional building materials.

Sandwich panels are generally constructed from one or more outer layers of laminate material and an insulative core. The outer layers of laminate may be formed from one or more layers of reinforcement material. Multiple layers of reinforcement material may be bonded together to form the laminate and to increase the strength and/or rigidity of the laminate and the sandwich panel.

A method can be used to form laminate out of multiple layers of reinforcement material to add strength and/or rigidity to the sandwich panel. The laminate may be formed by stacking two layers of reinforcement material on top of one another, wherein the first layer has a first glass fiber orientation and a second layer has a second glass fiber orientation. The first layer and the second layer may impregnated with a resin and connected together to form a laminate having a combination of the first and second glass fiber orientations.

According to one aspect of the invention, a system for forming a multi-axis laminate includes a production surface, a reinforcement material supply, and a resin supply, wherein the reinforcement material supply supplies a first layer of reinforcement material having a first fiber orientation to the production surface and a second layer of reinforcement material having a second fiber orientation on top of the first layer of reinforcement material, and wherein resin from the resin supply impregnates the first and the second layers of reinforcement material to form a laminate having a multi-axis fiber orientation.

According to another aspect, the first layer of reinforcement material has a tri-axis fiber orientation and the second layer of reinforcement material has a different tri-axis fiber orientation.

According to another aspect, the first layer of reinforcement material has a bi-axis fiber orientation and the second layer of reinforcement material has a different bi-axis fiber orientation.

According to another aspect, the first layer of reinforcement material and the second layer of reinforcement material are layered to form a quatro-axis laminate.

According to another aspect, the reinforcement material supply includes a first roll of reinforcement material.

According to another aspect, the first roll of reinforcement material is movable between a first position in which the reinforcement material has the first fiber orientation and a second position in which the reinforcement material has the second fiber orientation.

According to another aspect, the reinforcement material supply further includes a second roll of reinforcement material, wherein the first roll of reinforcement material has the first fiber orientation and the second roll of reinforcement material has the second fiber orientation.

According to another aspect, the reinforcement material is fiberglass.

According to another aspect, the reinforcement material is a natural material.

According to another aspect, the system further includes a carriage, wherein the carriage includes the reinforcement material supply, and the carriage is movable relative to the production surface to distribute the first and second layers of reinforcement material.

According to another aspect of the invention a method of producing a multi-axis laminate includes distributing a first layer of reinforcement material having a first fiber orientation, distributing a second layer of reinforcement material having a second fiber orientation on top of the first layer, and impregnating the layers of reinforcement material with a resin to bond the layers together to form a laminate having a multi-axis fiber orientation.

According to another aspect, the providing the first and second layers of reinforcement material includes supplying the reinforcement material from a roll of reinforcement material.

According to another aspect, the method further includes moving the roll of reinforcement material from the first position in which the reinforcement material has the first fiber orientation to the second position in which the reinforcement material has the second fiber orientation.

According to another aspect, first layer of reinforcement material is distributed from a first roll of reinforcement material and the second layer of reinforcement material is distributed from a second roll of reinforcement material.

According to another aspect, the distributing reinforcement material includes distributing reinforcement material from a carriage that is movable relative to the production table.

According to another aspect of the invention a method of producing a composite sandwich panel includes forming a first layer of multi-axis laminate from two layers of reinforcement material, each layer having a different fiber orientation, wherein the layers of reinforcement material are bonded to one another with a resin material, connecting the first layer of multi-axis laminate to a layer of core material, forming a second layer of multi-axis laminate from two layers of reinforcement material, each layer having a different fiber orientation, wherein the layers of reinforcement material are bonded to one another with a resin material, and connecting the second layer of quatro-axis laminate to the layer of core material.

According to another aspect, the forming of the first and second layers of multi-axis laminate includes forming a quatro-axis laminate from two layers of tri-axis reinforcement material.

According to another aspect, the method further includes supplying the layers of reinforcement material from a reinforcement material supply on a carriage by moving the carriage relative to a production surface on which the sandwich panel is formed.

According to another aspect, the supplying of the layers of reinforcement material includes supplying fiberglass with a tri-axis glass fiber orientation.

According to another aspect, the method further includes supplying the resin from a resin supply on a carriage, wherein the carriage is movable relative to a production surface on which the sandwich panel is formed.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

It should be emphasized that the term “comprises/comprising” when used in this specification is taken to specify the presence of stated features, integers, steps or components but does not preclude the presence or addition of one or more other features, integers, steps, components or groups thereof.

Features that are described and/or illustrated with respect to one embodiment may be used in the same way or in a similar way in one or more other embodiments and/or in combination with, or instead of, the features of the other embodiments.

### BRIEF DESCRIPTION OF THE DRAWINGS

FIG. 1 is an isometric view of an exemplary sandwich panel.

FIG. 2A is a schematic view of the fiber orientations of two layers of reinforcement material used to form a multi-axis laminate.

FIG. 2B is another schematic view of the fiber orientations of two layers of reinforcement material used to form a multi-axis laminate.

FIGS. 3A-3C illustrate a system for forming a multi-axis laminate.

FIGS. 4A-4D illustrate another embodiment of a system for forming a multi-axis laminate.

FIG. 5A-5B illustrate the formation of a sandwich panel with outer layers formed from a laminate having a multi-axis fiber orientation.

FIG. 6 is a schematic block diagram representing an exemplary method of forming a sandwich panel with multi-axis laminate outer layers.

### DETAILED DESCRIPTION OF EMBODIMENTS

In the detailed description that follows, like components have been given the same reference numerals regardless of whether they are shown in different embodiments of the invention. To illustrate the present invention in a clear and concise manner, the drawings may not necessarily be to scale and certain features may be shown in somewhat schematic form. Certain terminology is used herein to describe the different embodiments of the invention. Such terminology is used for convenience when referring to the figures. For example, “upward,” “downward,” “above,” “below,” “left,” or “right” merely describe directions in the configurations shown in the figures. Similarly, the terms “interior” and “exterior” or “inner” and “outer” may be used for convenience to describe the orientation of the components in the figures. The components can be oriented in any direction and the terminology should therefore be interpreted to include such variations. The dimensions provided herein are exemplary in nature and are not intended to be limiting in scope. Furthermore, while described primarily with respect to house construction, it will be appreciated that the concepts described herein are equally applicable to the construction of any type of structure or building, such as warehouses, commercial buildings, factories, apartments, etc.

Composite sandwich panels, which may be formed from synthetic or natural materials, provide a light-weight and less expensive alternative to conventional raw materials, e.g., wood, concrete, metal, etc. Sandwich panels are usually connected or joined together with a high-strength bonding material, such as epoxy or glue, and conventional materials, such as nails and screws, are not usually needed. The result is a strong and durable monolithic (e.g., single unit) structure.

Referring to FIG. 1, an exemplary sandwich panel 10 is illustrated. The sandwich panel has two outer layers 12, 14 separated by a core 16. The outer layers 12, 14 are made from a composite material that includes one or more layers of reinforcement material (such as fiberglass) and a matrix material or filler material (such as a resin or resin mixture). The reinforcement material may be a fiberglass material having one or more fiber orientations. For example, the reinforcement material may be fiberglass or glass fabric having a uni-axis, bi-axis, tri-axis, or quatro-axis glass fiber orientation, etc. Two or more layers of reinforcement material may be layered or stacked on top of one another and impregnated with a resin to form a laminate having glass fibers extending along multiple-axes. The multi-axis orientation of the fibers in the reinforcement material increases the strength and/or rigidity of the laminate by overlapping and/or reinforcing one another. The glass fibers also may direct forces acting on the sandwich panel in the direction of the glass fibers and the additional axes of glass fibers, therefore, may increase the loads that the laminate may be able to support.

As described below with respect to FIGS. 2A and 2B, different fiber orientations may be layered or stacked to form a laminate having a multi-axis fiber orientation. For example, the reinforcement material may be fiberglass having a tri-axis glass fabric orientation (as shown in FIG. 2A) or may be fiberglass having a bi-axis glass fabric orientation (as shown in FIG. 2B) or may be another material having a different fiber orientation. The layers of fiberglass may be layered or stacked to form a laminate having a quatro-axis glass fiber orientation (e.g., a laminate having glass fibers oriented along four axes), thereby increasing the load-bearing potential of the laminate over a single layer laminate. Although described primarily with respect to reinforcement material having a tri-axis fiber orientation, it will be appreciated that the description below is equally applicable to form a laminate having a multi-axis reinforcement material by stacking or layering two or more layers of reinforcement material having varying fiber orientations.

Referring to FIG. 2A, an exemplary embodiment of a multi-axis laminate is shown. The multi-axis laminate 18 is a quatro-axis laminate formed by a first layer of reinforcement material 19 having a first glass fiber orientation and a second layer of reinforcement material 20 having a second glass fiber orientation. As shown in FIG. 2A, the first layer of reinforcement material 19 is a layer of fiberglass having a tri-axis glass fiber orientation (e.g. with glass fibers extending along three axes). As illustrated in the adjacent three-axes graph 21, the glass fibers of the first layer 19 include glass fibers 22, 23, 24 that respectively extend in three directions or along three axes. The glass fibers extend in a first direction (e.g., along the 0 degree axis 22′), a second direction (e.g., along the +45 degree axis 23′), and a third direction (e.g., along the 90 degree axis 24′).

The second layer of reinforcement material 20 is a layer of fiberglass having a tri-axis glass fiber orientation that is different from the tri-axis glass fiber orientation of the first layer 19. As illustrated in the adjacent three-axes graph 25, the glass fibers of the second layer 20 include glass fibers 26, 27, 28 that respectively extend in three directions or along three axes. The glass fibers 26, 27, 28 of the second layer 20 extend, respectively, in a first direction (e.g., along the 0 degree axis 26′), a second direction (e.g., along the −45 degree axis 27′), and a third direction (e.g., along the 90 degree axis 28′).

The fiber orientations of the first layer 19 and second layer 20 are different at least in the sense that the first layer 19 includes fibers oriented along the +45 degree axis 23′, while the second layer 20 includes fibers oriented along the −45 degree axis 27′. In one embodiment, the first layer 19 is rotated or turned by 180-degrees to form the second layer 20, such that the only difference between the two layers is the orientation of the fibers in the direction of the third axis (e.g., along axis 23′ and axis 27′).

The multi-axis laminate, e.g., quatro-axis laminate 18, is formed by stacking the second layer 20 on top of the first layer 19 and impregnating the layers 19, 20 with resin material. The resulting laminate 18 has glass fibers oriented in four directions or axes, which are illustrated in the four-axes graph 29 adjacent to the quatro-axis laminate 18. The glass fibers in the quatro-axis laminate 18 extend in a first direction (e.g., along the 0 degree axis 30′), a second direction (e.g., along the +45 degree axis 33′), a third direction (e.g., along the 90 degree axis 31′), and a fourth direction (e.g., along the −45 degree axis 32′).

It will be appreciated that the first layer 19 and second layer 20 may be impregnated with resin at the same time or separately from one another. For example, for thicker layers of reinforcement material, such as layers of fiberglass that are about 750 g/m², the first layer 19 may be impregnated with resin prior to the placement of the second layer 20, and the second layer 20 may be impregnated after it is stacked on top of the first layer 19. Alternatively, for thinner layers of reinforcement material, such as layers of fiber glass that are about 200-500 g/m², the first layer 19 and the second layer 20 may be stacked on top of one another and both layers may be impregnated with resin at the same time. It will be appreciated that the above exemplary thickness are illustrative in nature and thicker or thinner layers may be used. Furthermore, thinner layers may be impregnated separately from one another and that thicker layers may be impregnated at the same time, etc. It also will be appreciated that the layers may be impregnated by applying multiple layers of resin.

In the embodiment of the multi-axis laminate 18′ in FIG. 2B, the first layer 19′ and the second layer 20′ of reinforcement material may each have a bi-axis fiber orientation. For example, as illustrated in the graph 34 adjacent to the first layer 19′, the glass fibers 35, 36 respectively extend in two directions or along two axes 35′, 36′. The glass fibers 35 extend in a first direction (e.g., along the 0 degree axis 35′) and the glass fibers 36 extend in a second direction (e.g., along the 90 degree axis 36′). As illustrated by the graph 37 adjacent to the second layer 20′, the glass fibers 38, 39 of the second layer 20′ include fibers 38 that extend in a first direction (e.g., along the +45 degree axis 38′) and fibers 39 that extend in a second direction (e.g., along the −45 degree axis 39′).

The first layer 19′ and the second layer 20′ are impregnated and stacked on top of one another to form the multi-axis laminate 18′. As illustrated by the graph 40 adjacent to the multi-axis laminate 18′, the fibers 30′, 31′, 32′, 33′ are oriented in four directions or along four axes (e.g., the 0 degree axis 30″, the 90 degree axis 31″, the −45 degree axis 32″ and the +45 degree axis 33″).

As will be appreciated, the first and second layers may have any of a number of different fiber orientations to obtain a multi-axis laminate having fibers oriented along a number of different axes.

As described in more detail below, the first layer 19 and the second layer 20 may be provided from one or more rolls that are supplied from a carriage 41 (also referred to as a cart) that is movable relative to a production table 42, also referred to as a “production surface”. The production table 42 may be any surface used to apply, spread or distribute the layers of reinforcement material to construct the multi-axis laminate and/or a laminate material or sandwich panel.

As shown in FIGS. 3A-3C, the layers of reinforcement material 19, 20 are supplied or distributed from separate supply rolls 44, 46 on a carriage 41, e.g., the first layer 19 may be supplied from a first roll 44 of reinforcement material and the second layer 20 may be supplied from a second roll of material 46. The first roll 44 has a first fiber orientation and the second roll 46 has a second fiber orientation. Alternatively, as shown in FIGS. 4A-4D, the first and second layers 19, 20 may be supplied by a single supply of reinforcement material, such as roll 48, which may be rotated or turned by 180-degrees on the carriage 41′ to change the orientation of the glass fibers for the first and second layers 19, 20.

Referring back to FIG. 1, the outer layers 12, 14 of the sandwich panel 10 are made from a composite material that includes a matrix material and a filler or reinforcement material. Exemplary matrix materials include a resin or mixture of resins, e.g., epoxy resin, polyester resin, vinyl ester resin, natural (or non oil-based) resin or phenolic resin, etc. Exemplary filler or reinforcement materials include fiberglass, glass fabric, carbon fiber, or aramid fiber, etc. Other filler or reinforcement materials include, for example, one or more natural fibers, such as, jute, coco, hemp, or elephant grass, balsa wood, or bamboo.

The outer layers 12, 14 (also referred to as laminate) may be relatively thin with respect to the panel core 16. The outer layers 12, 14 may be several millimeters thick and may, for example, be between about 1 mm (millimeter)-12 mm (millimeters) thick; however, it will be appreciated that the outer layers can be thinner than 1 mm (millimeter) or thicker than 12 mm (millimeters) as may be desired. In one embodiment, the outer layers are about 1-3 mm (millimeters) thick.

It will be appreciated that the outer layers 12, 14 may be made thicker or may be strengthened by layering or stacking several layers of reinforcement material on top of one another. The thickness of the reinforcement material also may be varied to obtain thicker outer layers 12, 14 with a single layer of reinforcement material. Further, different reinforcement materials may be thicker than others and may be selected based upon the desired thickness of the outer layers. As described in more detail throughout, the laminate may be formed from a number of layers of reinforcement material having different fiber orientations.

The panel core 16 separates the outer layers 12, 14 of the sandwich panel 10. The panel core 16 may be formed from a light-weight, insulative material, for example, polyurethane, expanded polystyrene, polystyrene hard foam, Styrofoam® material, phenol foam, a natural foam, for example, foams made from cellulose materials, such as a cellulosic corn-based foam, or a combination of several different materials. Other exemplary panel core materials include honeycomb that can be made of polypropylene, non-flammable impregnated paper or other composite materials. It will be appreciated that these materials insulate the interior of the structure and also reduce the sound or noise transmitted through the panels, e.g., from one outer surface to the other or from an exterior to an interior of a building structure, etc. The panel core 16 may be any desired thickness and may be, for example, 30 mm (millimeters)-100 mm (millimeters) thick; however, it will be appreciated that the core can be thinner than 30 mm (millimeters) or thicker than 100 mm (millimeters) as may be desired. In one embodiment, the core is about 40 mm (millimeters) thick.

The outer layers 12, 14 are adhered to the core 16 with the matrix materials, such as the resin mixture. Once cured, the outer layers 12, 14 of the sandwich panel 10 are firmly adhered to both sides of the panel core 16, forming a rigid building element. It will be appreciated that the resin mixture also may include additional agents, such as, for example, flame retardants, mold suppressants, curing agents, hardeners, etc. Coatings may be applied to the outer layers 12, 14, such as, for example, finish coats, paint, ultraviolet (UV) protection, water protection, etc.

The panel core 16 may provide good thermal insulation properties and structural properties. The outer layers 12, 14 may add to those properties of the core and also may protect the panel core 16 from damage. The outer layers 12, 14 also may provide rigidity and support to the sandwich panel 10.

The sandwich panels may be any shape and size. In one embodiment, the sandwich panels are rectangular in shape and may be several meters, or more, in height and width. The sandwich panels also may be other shapes and sizes. The combination of the panel core 16 and outer layers 12, 14 create sandwich panels with high ultimate strength, which is the maximum stress the panels can withstand, and high tensile strength, which is the maximum amount of tensile stress that the panels can withstand before failure. The compressive strength of the panels is such that the panels may be used as both load bearing and non-load bearing walls. In one embodiment, the panels have a load capacity of at least 50 tons per square meter in the vertical direction (indicated by arrows V in FIG. 1) and 1 tons per square meter in the horizontal direction (indicated by arrows H in FIG. 1). The sandwich panels may have other strength characteristics as will be appreciated in the art.

Internal stiffeners may be integrated into the panel core 16 to increase the overall stiffness of the sandwich panel 10. In one embodiment, the stiffeners are made from materials having the same thermal expansion properties as the materials used to construct the panel, such that the stiffeners expand and contract with the rest of the panel when the panel is heated or cooled.

The stiffeners may be made from the same material used to construct the outer layers of the panel. The stiffeners may be made from composite materials and may be placed perpendicular to the top and bottom of the panels and spaced, for example, at distances of about 10 cm (centimeters), 25 cm, 50 cm, or 100 cm. Alternatively, the stiffeners may be placed at different angles, such as a 45-degree angle with respect to the top and bottom of the panel, or at another angle, as may be desired.

Referring to FIGS. 3A-3C, an exemplary system 50 for forming a sandwich panel having a multi-axis laminate 18 is shown. The system 50 includes the carriage 41 and production surface 42, which may, for example, be a production table on which the layer(s) can be applied or spread to form the laminate and/or sandwich panel. The carriage 41 is moveable relative to the production table 42 to distribute or to apply the raw materials used to produce the laminate, for example, reinforcement material, resin, resin mixtures, hardener, and/or additives (such as retardants or suppressants), etc. The carriage 41 also includes a number of legs 52 and wheels 54 or casters on which the carriage 41 may be moved relative to the production table 42. As will be appreciated, the legs 52 and wheels 54 may engage a track or other guiding mechanism on the production table 42 to facilitate the movement of the carriage 41 relative to the production table 42. Although shown as legs 52 and wheels 54, it will be appreciated that other mechanisms may be used to move the carriage 41 relative to the production table 42, such as a motor, pulley system, sliders, etc.

The production table 42 includes a generally planar or flat surface 42s on which the respective layers of the sandwich panel may be applied or be distributed. The production table 42 may include a number of additional components, such as a lid or closing mechanism, a vacuum source, a heat source, etc., which may be used during the manufacturing of the sandwich panels and to facilitate panel production.

The system 50 includes a supply of reinforcement material. The reinforcement material may be supplied in roll form. The roll of reinforcement material may be carried on the carriage 41, or may be supplied from another location, for example, a stationary cart or roll supply at one end of the table.

The carriage 41 is movable relative to the production surface 42s to supply or to distribute the layers of reinforcement material 19, 20 on the production surface 42s. As shown in FIGS. 3A-3C, the first layer of reinforcement material 19 having a first fiber orientation is supplied or distributed from a roll 44 and the second layer of reinforcement material 20 having a second fiber orientation is supplied or distributed from a roll 46. The rolls 44, 46 may be rolls of fiberglass material having a multi-axis fiber orientation or another material having a multi-axis fiber orientation, including, for example, the natural materials described above with respect to FIG. 1.

As described above with respect to FIG. 2A the first roll 44 supplying the first layer 19 may have a tri-axis fiber orientation (e.g., with glass extending along the 0 degree, +45 degree, and 90 degree axes), and the second roll 46 supplying the second layer 20 may have a tri-axis fiber orientation (e.g., with glass fibers extending along the 0 degree, −45 degree, and 90 degree axes). The carriage 41 also includes a supply of resin 56 and a nozzle 58 to apply resin to the layers 19, 20 of reinforcement material. The reinforcement material may be supplied from one or more rolls of material, which may be carried on the carriage 41, or which may be supplied from another source, as will be appreciated.

As shown in FIG. 3A, the carriage 41 is movable relative to the production table 42 in a first direction A to provide or to spread the first layer 19 of the reinforcement material. The first layer of reinforcement material 19 is supplied from the first roll 44, and may be spread by unwinding the material from the roll 44. The first layer 19 may be smoothed or spread on the production table 42 into a flat layer of material. The first layer 19 may be spread along a portion of the production table 42 or along the entire length of the table, depending on the desired size of the sandwich panel that is being manufactured.

After the first layer 19 is spread on the production table, it is impregnated with a layer of resin 60 from the resin supply 56. The resin 60 is supplied to the nozzle(s) 58 from the resin supply 56, and the nozzle(s) 58 are used to spray or apply the resin onto the first layer 19.

As shown in FIG. 3B, the carriage 41 is movable relative to the production table 42 in direction B. The layer of resin 60 is applied to the surface of the first layer of the reinforcement material 19. It will be appreciated that it may be necessary to manually spread or smooth the layer 60 of resin, for example, with brushes, rollers or other spreading tools.

The resin supply 56 is in fluidic connection with an applicator, such as one or more nozzles 58 on the carriage 41. The first reinforcement layer 19 is impregnated with resin by spraying the surface of the layer 19 with resin from the nozzle 58. The resin may be spread by spraying the resin through the nozzle(s) 58, and the carriage 41 may include a pump or other mechanism for pressurizing the resin and/or increasing the resin flow through the nozzle(s) 58. The resin supply 56 may be a reservoir, tank or other supply, and it will be appreciated that the resin may be stored remote from the carriage 41, or supplied to the carriage 41 from a remote source. A number of hoses or tubes may be coupled to the nozzles 58 and/or a pump or other mechanism for mixing and/or pumping the resin through the nozzles 58.

As shown in FIG. 3C, the carriage 41 is moved relative to the production table 42 in direction A to provide or to spread the second layer 20 of the reinforcement material 20. The second layer of reinforcement material 20 is applied on top of the first layer of reinforcement material 19. The second layer of reinforcement material 20 is supplied from the second roll 46. The reinforcement material may be in sheet form on the roll 41 and may be spread by unwinding the material from the roll 44. The second layer 20 may be smoothed or spread on the production table 42 into a flat layer of material. The second layer 20 may be cut, for example, with a cutting implement, such as a knife, for example, at the end of the production table 42 or elsewhere relative to the production table 42. In one embodiment, the length of the second layer 20 is generally about the same as the length of the first layer 19 so that the multi-axis laminate 18 includes both layers 19, 20 over the entire extent thereof. If desired, however, the layers 19, 20 may be different sizes such that part of the laminate 18 is composed of both layers 19, 20 and part is composed of any one of these layers.

The second layer of reinforcement material 20 is impregnated with resin in the same or a similar manner as the first layer 19 is impregnated, e.g., by the nozzle(s) 58 and by moving the carriage 41 relative to the production table 42 in direction B (as described above with respect to FIG. 3B) and spraying or applying a layer of resin to the surface of the second layer of reinforcement material 20. While impregnating the layers 19, 20, both layers become one laminate with four axes (e.g., the layers 19, 20 are bonded together to form a single layer).

The first layer 19 and the second layer 20 may be fiberglass having a multi-axis glass fiber orientation, such as the tri-axis fiber orientations illustrated in FIGS. 2A and 2B and described above. As described above, the two layers 19, 20 of tri-axis (or as shown in FIG. 2B, bi-axis: 0°, 90° and +45°, −45°) fiberglass are stacked or layered to form a quatro-axis laminate 18. The quatro-axis laminate 18 may be used as an outer layer (e.g., outer layer 12) of the sandwich panel 10. It will be appreciated that the second outer layer (e.g. outer layer 14) of the sandwich panel 10 may be formed in the same or a similar manner. Alternatively, the second outer layer 14 may be a tri-axis laminate or another material.

In the embodiment of FIGS. 4A-4D, the carriage 41′ includes a single supply or roll 48 of reinforcement material 48′ rather than two rolls 44, 46 as shown in the system of FIGS. 3A-3C. The roll 48 is movable between a first position in which the reinforcement material 48′ has a first fiber orientation, e.g., as layer 19, and a second position in which the reinforcement material has a second fiber orientation e.g., as layer 20. The first layer of reinforcement material 19 may be spread on the production table 42 and be impregnated with resin 60 in the same or a similar manner as described above with respect to FIGS. 3A-3B.

After the application of a layer of resin 60 to the first layer 19, the roll 48 of reinforcement material 48′ may be moved, turned, rotated or flipped to change the fiber orientation of the fiberglass or other reinforcement material on the roll 48 from the first fiber orientation to the second fiber orientation, e.g. as layer 20. For example, if the first layer 19 is fiberglass having a tri-axis glass fiber orientation with glass fibers in the 0 degree, +45 degree and 90 degree directions, then the roll is rotated or flipped such that the orientation of the glass fibers in the second layer is 0 degrees, −45 degrees, and 90 degrees. The first layer 19 and second layer 20 are stacked or layered on top of one another. While impregnating the layers 19, 20, both layers become one laminate with four axes (e.g., the resin bonds the layers 19, 20 together to form the laminate with the multi-axis fiber orientation). As described above, the second layer 20 may be impregnated with resin in a similar manner.

As an example, referring to FIG. 4D, the roll 48 of reinforcement material 48′ may be mounted in or on the carriage 41′ by a bracket 62, cables 64, a swivel or turnbuckle 66, and a support rod 68. To change orientation of fibers to form layers 19, 20, the roll 48 may be rotated about the axis of the support rod 68 by manually or automatically turning the roll 48 and bracket 62 about the swivel 66, e.g., as is represented by arrow 69. If desired, the reinforcement material 48′ may be cut before, during, or after the roll 48 is rotated or turned about the axis of the support rod 68 to avoid fold or kinks in the material.

Referring to FIGS. 5A-5B, a sandwich panel is formed by applying a layer of core material 72 on top of a first quatro-axis laminate 18 formed from layers 19, 20. A second quatro-axis laminate 18a (FIG. 5B) may be formed in the same or a similar manner. For example, the roll of reinforcement material 48 may be applied to form a first layer 19a, having a first glass fiber orientation and then turned to form a second layer 20a having a second glass fiber orientation. The first layer 19a and second layer 20a may be impregnated with resin and stacked on top of one another to form a quatro-axis laminate. The quatro-axis laminate may be connected to the core 72 with a resin material.

Referring to FIG. 6, a method 200 of forming a sandwich panel having quatro-axis laminate 18 outer layers is shown.

At Step 202 a first layer of reinforcement material 19 having a first fiber orientation is provided from the reinforcement supply 44. The first layer 19 is spread on the production table 42. The first layer 19 may be spread by moving the cart or carriage 41 relative to the production table 42 (e.g., in direction A) to unroll or unwind the reinforcement material from a roll 44 to form the first layer 19. Alternatively, the layers 32 may be provided by a stationary reinforcement material supply, such as a stationary roll of material, or may be provided in another manner.

At Step 204, the first layer 19 is impregnated with resin by spreading a layer 60 of resin on the surface of the first layer 19. The resin may be supplied from the resin supply 56, such as a reservoir or other resin supply and may be pumped through one or more nozzles 58 as the carriage 41 is moved across the production table 42 in direction B. It will be appreciated that the resin supply may be separate from the carriage or may be located remote from the carriage.

At Step 206, a second layer of reinforcement material is supplied from the reinforcement material supply. The carriage 41 is moved back across the production table in direction A in Step 206 to lay down a second layer 20 of reinforcement material having a second fiber orientation, which is different from the first fiber orientation of the first layer 19. The second layer 20 may be supplied from a second roll or supply 46 of material (e.g., as is shown in FIGS. 3A-3C), or the roll of material 48 can be moved or be rotated to change the fiber orientation (e.g., as is shown in FIGS. 4A-4C), etc.

The second layer of reinforcement material 20 is impregnated with resin at Step 208 by moving the carriage 41 with respect to the production table 42 in direction B and applying the resin through one or more nozzles 58. The first layer 19 and the second layer 20 may be fiberglass with a tri-axis glass fiber orientation. By stacking the first layer 19 and second layer 20 on top of one another, a first quatro-axis laminate 18 is formed.

In Step 210 a layer of core material 72 placed on top of the first quatro-axis laminate. The core 72 may be connected to the quatro-axis laminate 18 by a layer of resin or another adhesive or bonding material as described above with respect to FIG. 1. The core 72 may be connected to a second outer layer formed in Steps 212-218 in a similar manner.

A second quatro-axis laminate 18a or second outer layer of the sandwich panel is formed in Steps 212-218 in the same or a similar manner to the first quatro-axis laminate 18 described with respect to Steps 202-208. The second laminate 18a is therefore symmetric to the first laminate 18. In Step 212, a layer of reinforcement material (e.g., layer of reinforcement material 20a (FIG. 5A)) is provided from the reinforcement supply and spread on the core 72 by moving the carriage 41 in direction A and unwinding the reinforcement material from a roll or other source. In Step 214 the layer 20a is impregnated with resin by spreading or applying a layer of resin to the surface of layer 20a by moving the carriage 41 in direction B and applying the resin through one or more nozzles 58. In Step 216, another layer of reinforcement material (e.g., layer of reinforcement material 19 (FIG. 5B)), having a different glass fiber orientation from the layer 20a, is applied on top of the layer 20a by unwinding the reinforcement material from the reinforcement material supply 48 and moving the carriage 41 in direction A. The layer 19a may be impregnated with resin by spreading or applying resin to the surface of the layer 34a in Step 218.

Each outer layer of the sandwich panel 10 may be a laminate having a multi-axis fiber orientation, e.g., the quatro-axis laminate 18, formed from two layers of reinforcement material and a single or double layer of resin. The resin cures or solidifies to connect the respective layers of reinforcement material (e.g., layers 19, 20) and to form a strong, relatively rigid outer layer for the sandwich panel. The quatro-axis laminate outer layers protect the panel core 72 from damage and also add strength and rigidity to the sandwich panel.

Although described with respect to FIG. 6 as having certain steps, it will be appreciated that additional steps and/or variations of the method are also described with respect to FIGS. 1-5B above, and such additional steps and/or variations may be included as part of the method of forming the sandwich panel.

Although the invention has been shown and described with respect to a certain preferred embodiment or embodiments, it is obvious that equivalent alterations and modifications will occur to others skilled in the art upon the reading and understanding of this specification and the annexed drawings.

What is claimed is:

1. A system for forming a multi-axis laminate comprising:
a production surface;
a reinforcement material supply; and
a resin supply, wherein the reinforcement material supply supplies a first layer of reinforcement material having a first fiber orientation to the production surface and a second layer of reinforcement material having a second fiber orientation on top of the first layer of reinforcement material, and wherein resin from the resin supply impregnates the first and the second layers of reinforcement material to form a laminate having a multi-axis fiber orientation.

2. The system of claim 1, wherein the first layer of reinforcement material and the second layer of reinforcement material are layered to form a quatro-axis laminate.

3. The system of claim 1, wherein the first layer of reinforcement material has a bi-axis fiber orientation and the second layer of reinforcement material has a different bi-axis fiber orientation.

4. The system of claim 1, wherein the first layer of reinforcement material has a tri-axis fiber orientation and the second layer of reinforcement material has a different tri-axis fiber orientation.

5. The system of claim 1, wherein the reinforcement material supply comprises a first roll of reinforcement material.

6. The system of claim 5, wherein the first roll of reinforcement material is movable between a first position in which the reinforcement material has the first fiber orientation and a second position in which the reinforcement material has the second fiber orientation.

7. The system of claim 5, wherein the reinforcement material supply further comprises a second roll of reinforcement material, wherein the first roll of reinforcement material has the first fiber orientation and the second roll of reinforcement material has the second fiber orientation.

8. The system of claim 1, wherein the reinforcement material is fiberglass.

9. The system of claim 1, wherein the reinforcement material is a natural material.

10. The system of claim 1, further comprising a carriage, wherein the carriage includes the reinforcement material supply, and the carriage is movable relative to the production surface to distribute the first and second layers of reinforcement material.

11. A method of producing a multi-axis laminate comprising:
distributing a first layer of reinforcement material having a first fiber orientation;
distributing a second layer of reinforcement material having a second fiber orientation on top of the first layer; and
impregnating the layers of reinforcement material with a resin to bond the layers together to form a laminate having a multi-axis fiber orientation.

12. The method of claim 11, wherein the providing the first and second layers of reinforcement material includes supplying the reinforcement material from a roll of reinforcement material.

13. The method of claim 12, further comprising moving the roll of reinforcement material from the first position in which the reinforcement material has the first fiber orientation to the second position in which the reinforcement material has the second fiber orientation.

14. The method of claim 11, wherein first layer of reinforcement material is distributed from a first roll of reinforcement material and the second layer of reinforcement material is distributed from a second roll of reinforcement material.

15. The method of claim 11, wherein the distributing reinforcement material includes distributing reinforcement material from a carriage that is movable relative to the production table.

16. A method of producing a composite sandwich panel comprising:
forming a first layer of multi-axis laminate from two layers of reinforcement material, each layer having a different fiber orientation, wherein the layers of reinforcement material are bonded to one another with a resin material;
connecting the first layer of multi-axis laminate to a layer of core material;
forming a second layer of multi-axis laminate from two layers of reinforcement material, each layer having a different fiber orientation, wherein the layers of reinforcement material are bonded to one another with a resin material; and
connecting the second layer of quatro-axis laminate to the layer of core material.

17. The method of claim 16, wherein the forming of the first and second layers of multi-axis laminate includes forming a quatro-axis laminate from two layers of tri-axis reinforcement material or two layers of bi-axis reinforcement material.

18. The method of claim 16, further comprising supplying the layers of reinforcement material from a reinforcement material supply on a carriage by moving the carriage relative to a production surface on which the sandwich panel is formed.

19. The method of claim 18, wherein the supplying of the layers of reinforcement material includes supplying fiberglass with a tri-axis glass fiber orientation.

20. The method of claim 16, further comprising supplying the resin from a resin supply on a carriage, wherein the carriage is movable relative to a production surface on which the sandwich panel is formed.
